(19) United States
(12) Patent Application Publication
(10) Pub. No.: US 2025/0326614 A1
(43) Pub. Date: Oct. 23, 2025

(54) COMBINATION TWO POST VEHICLE AND BATTERY LIFT

(71) Applicant: BendPak, Inc., Agoura Hills, CA (US)

(72) Inventor: Jeffrey S. Kritzer, Moorpark, CA (US)

(73) Assignee: BendPak, Inc., Agoura Hills, CA (US)

(21) Appl. No.: 19/243,320

(22) Filed: Jun. 19, 2025

Related U.S. Application Data
(62) Division of application No. 18/652,607, filed on May 1, 2024, now Pat. No. 12,358,769.
(60) Provisional application No. 63/499,291, filed on May 1, 2023.

(51) Int. Cl. B66F 7/26; B60L 53/80

(52) U.S. Cl. CPC B66F 7/26; B60L 53/80

(57) ABSTRACT

A combination two post vehicle and battery lift includes a pair of upstanding post assemblies, each having a vehicle lift assembly and battery lift assembly. Each lift assembly includes a lift carriage having lift arms articulated thereto. The lift assemblies are operated in coordination to lift and lower an electric vehicle and a battery in relation to the vehicle.

### CROSS-REFERENCE TO RELATED APPLICATIONS

This application and is a divisional application of U.S. application Ser. No. 18/652,607, filed May 1, 2024, that claims the benefit of U.S. Provisional Patent Application No. 63/499,291, filed May 1, 2023, each of the disclosures of which are hereby incorporated by reference herein.

### BACKGROUND OF THE INVENTION

### Field of the Invention

This invention relates to automobile service lifts and, more particularly, to a combination two-post lift for both an electric vehicle and a battery for propelling the vehicle.

### Background & Description of Related Art

A wide variety of post-type automobile lifts have been previously known and used in automobile maintenance and repair to provide access to components on the lower or undersides of vehicles such as tires, brakes, exhaust components, and the like for inspection, repair, and replacement purposes. Post lifts can be in-ground varieties with some components below the floor surface of the shop or above-ground varieties which are mounted on the floor. In-ground post lifts usually have one or two vertically ascending columns mounted below the floor of a service facility, such as a garage, shop, or the like that are raised hydraulically or pneumatically to lift the vehicle. Above-ground post lifts generally have two or four vertical columns or posts, each of which includes a carriage that rides up and down the post. Each of the carriages of a two post lift includes a pair of inwardly extending lift arms with vehicle engagement structure, such as lift pads, at ends thereof that engage lift points or locations on the underside of a body or frame of a vehicle to be lifted. The lift arms are adjusted in length and angular position to engage front and back and left and right lift points of the vehicle.

The vehicle lift arms are typically formed of telescoping sections which are pivotally connected to the lift carriage that is slidably mounted on the post and selectively movable vertically on the post by an actuator, such as a pressurized fluid cylinder connected between the lift carriage and the post. The telescoping lift arm sections enable adjustment of the lengths of the lift arms, and the pivotal connection of the arms to the lift carriage enables adjustment of the angles thereof to allow the lift system to accommodate a variety of vehicle sizes and proportions. The lengths of the lift arms and their angular positions relative to the lift carriage are usually adjusted manually by a mechanic to position the lift pads for engagement with particular lift points of the vehicle. Representative types of such two-post vehicle lift systems are disclosed in U.S. Pat. No. 9,150,395, and U.S. Publication Nos. 2021/0331904 and 2022/0017342, the disclosures of which are incorporated herein in their entirety by reference.

Electrically propelled vehicles, such as automobiles, employ very large rechargeable battery packs to operate propulsion motors. Such vehicles are referred to as electric vehicles (EV's) when propelled solely by a battery or as hybrids if an internal combustion engine is incorporated into the vehicle. Although the batteries for electric vehicles typically have long lives, replacement may eventually be required. Manufacturing defects in the batteries and other circumstances may require earlier replacement. The batteries for electric vehicles may range in weight from about 200 to 500 kilograms (400 to 1200 pounds) or more for passenger vehicles and are usually accessible from beneath the vehicle for replacement. Batteries for full sized electrically propelled pickup trucks, delivery vehicles, and the like are even larger and heavier.

The battery pack or battery of an electric vehicle is typically a large, relatively flat assembly which is secured within a large shallow recess or well on the underside of the vehicle by removable fasteners. The battery is electrically connected to the vehicle electrical motor and systems by separable connectors. For removal, the battery is supported from below while fasteners are removed. The battery is then lowered which enables components of the electrical connectors to separate. The process for installing a new battery reverses the removal process. However, installation of the battery requires precise alignment of components of the mechanical fasteners and electrical connectors prior lifting the battery into the battery recess.

Apparatus and mechanisms have been developed for use with existing two-post lift systems for lifting and lowering an EV battery pack in relation to a vehicle supported by the lift system. Such an EV battery lift is described in U.S. Publication No. US 2022/0402735, the disclosure of which is incorporated herein in its entirety by reference. Such a battery lift may include hydraulic lift actuators, along with a motor, pump, and reservoir for the actuators.

### SUMMARY OF THE INVENTION

The present invention provides embodiments of a two-post lift apparatus which incorporates lift members both for an electric vehicle and the battery for propelling the vehicle which operate in coordination on the two lift posts.

An embodiment of a two-post lift apparatus for lifting and lowering a vehicle and a vehicle component, such as a battery for propelling the vehicle and comprising: first and second lift post assemblies upstanding from a support surface and positioned in laterally spaced relation, each lift post assembly having a primary or vehicle lift track and a secondary or battery lift track extending therealong in spaced apart, parallel relation; each vehicle lift track having a respective primary or vehicle lift carriage positioned therein to enable travel therealong, and each battery lift track having a respective secondary or battery lift carriage positioned therein to enable travel therealong; a vehicle lift actuator assembly engaged between the vehicle lift carriages and the lift post assemblies and operable to enable movement of the vehicle lift carriages along the associated vehicle lift track; a battery lift actuator assembly engaged between the battery lift carriages and the lift post assemblies and operable to enable movement of the battery lift carriages along the associated battery lift track; each vehicle lift carriage having a respective pair of vehicle lift arms or primary lift arms connected thereto to in such a manner as to enable selective engagement thereof with an underside of a vehicle; each battery carriage having a respective pair of battery lift arms or secondary lift arms connected thereto in such a manner as to enable selective engagement thereof with an underside of a battery of a vehicle; and the vehicle lift actuator assembly and the battery lift actuator assembly being controlled in such a manner as to enable selective lifting and lowering of a vehicle and a battery of the vehicle.

In an embodiment of the two post lift apparatus, the vehicle lift actuator assembly may include a respective vehicle lift actuator positioned within each lift post assembly and engaged between the lift post assembly and vehicle lift carriage engaged therewith. The lift apparatus may include an elongated trough member extending between upper ends of the lift post assemblies, and the battery lift actuator assembly may include a battery lift actuator supported by the trough member and engaged with the trough member and each of the battery lift carriages.

In an embodiment of the combination lift apparatus, the primary or vehicle lift tracks are positioned on inward sides of their respective post assemblies in mutually inwardly facing relation, and the secondary or battery lift tracks are positioned on outward sides of their respective post assemblies in mutually outwardly facing relation. Each of the lift arms is pivotally connected to its respective lift carriage; and each of the lift arms is extendible and retractable and has a contact member positioned at an outer end thereof to enable flexible selective positioning of the contact member relative to a load, such as the vehicle or vehicle component, to be lifted thereby. In an embodiment of the combination lift system, the contact member for the battery lift arms may include: an elongated stiffener member extending between outer ends of the battery lift arms; and a pair of battery contact pads positioned on the stiffener member in longitudinally spaced relation thereon.

In an embodiment of the combination lift system, the contact member for the battery lift arms may include a respective battery lift extension upstanding from an end of each battery lift arm; an elongated stiffener member engaged with each battery lift extension; and a pair of battery contact pads positioned on the stiffener member in longitudinally spaced relation thereon. Each battery lift extension may include a swivel member connecting it to its associated battery lift arm to enable rotation of the battery lift extension about a respective vertical axis. The stiffener member may engage each battery lift extension in such a manner as to enable the stiffener member to slide in a longitudinal direction thereof relative to the stiffener member lift extension; and each battery contact pad may be slidable engaged with the associated battery lift extension.

In an embodiment of the combination lift system, an elongated trough member extends between upper ends of the post assemblies, and a battery lift actuator is positioned within the trough member and is engaged with each battery lift carriage in such a manner as to enable coordinated lifting and lowering of the battery lift arms. The battery lift arms may be configured to enable folding thereof to such positions as to enable the vehicle lift arms to be lowered sufficiently for engagement with the underside of a vehicle positioned on the support surface.

In an embodiment of the combination lift system, a contact adapter to engage a load to be lifted may include: a contact receiver positioned at an end of a lift arm of the system; a contact adapter member configured to be removably engaged with the contact receiver; and the contact adapter member having an upper shape which is compatible with a shape of a contact element of the load to be lifted in order to provide substantially non-slip engagement of the contact adapter member with the contact element. A contact spacer may be engaged between the contact adapter member and the contact receiver to position the contact adapter member at a selected height above the lift arm of the lift system.

Various objects and advantages of the present invention will become apparent from the following description taken in conjunction with the accompanying drawings wherein are set forth, by way of illustration and example, certain embodiments of this invention.

The drawings constitute a part of this specification, include exemplary embodiments of the present invention, and illustrate various objects and features thereof.

### BRIEF DESCRIPTION OF THE DRAWINGS

FIG. 1 is a perspective view of a two-post vehicle and battery lift system embodying the present invention.

FIG. 2 is an enlarged bottom plan view of the lift system supporting an electric vehicle and a battery for propelling the vehicle.

FIG. 3 is a perspective view of the lift system shown supporting a battery of an electric vehicle.

FIG. 4 is a further enlarged perspective view a battery lift assembly of the lift apparatus.

FIG. 5 is a further enlarged fragmentary perspective view of one end of a stiffener link and battery contact pad of the battery lift assembly.

FIG. 6 is a fragmentary exploded perspective view of a vehicle lift arm along with a contact pad and an adapter for the contact pad.

FIG. 7 is a view similar to FIG. 6 and illustrates several alternative embodiments of contact pad adapters for a vehicle lift arm of the lift system.

FIG. 8 is a fragmentary perspective view of a cross-over trough member of the lift system, including an actuator for the battery lift assemblies.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

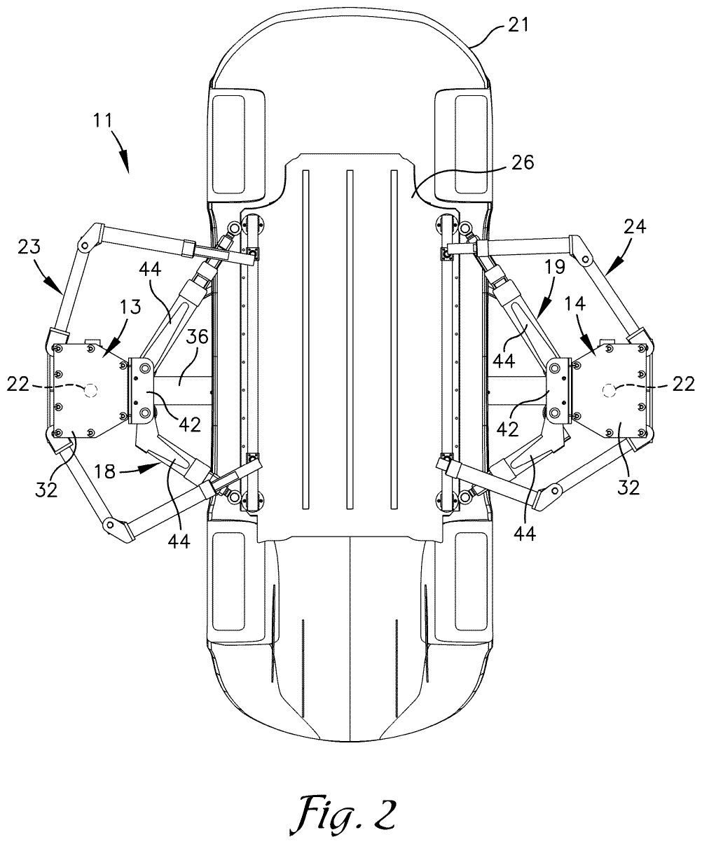

Referring to the drawings in more detail, the reference number 11 generally designates an embodiment of a combination two-post lift apparatus according to the present invention. In general, the two-post lift apparatus 11 includes an elongated right post assembly 13 and an elongated left post assembly 14 upstanding in laterally spaced relation from a support surface 16. The left and right post assemblies may also be referred to as first and second lift post assemblies. A right vehicle lift assembly 18 is slidably engaged with the right post assembly 13, and a left vehicle lift assembly 19 is slidably engaged with the left post assembly 14. The vehicle lift assemblies 18 and 19 are operated in coordination to lift and lower a vehicle, such as an electric vehicle or EV 21 (FIG. 2), with respect to the surface 16.

Additionally, a right battery lift assembly 23 is slidably engaged with the right post assembly 13, and a left battery lift assembly 24 is slidably engaged with the left post assembly 14. The battery lift assemblies 23 and 24 are operated in mutual coordination, and in coordination with the vehicle lift assemblies 18 and 19, to lift and lower a battery pack or battery 26 (FIG. 2) with respect to the vehicle 21. The vehicle lift assemblies may also be referred to as primary lift assemblies and the battery lift assemblies may also be referred to as secondary lift assemblies or vehicle component lift assemblies. In one embodiment, the battery 26 is a battery adapted to provide sufficient power to propel the vehicle.

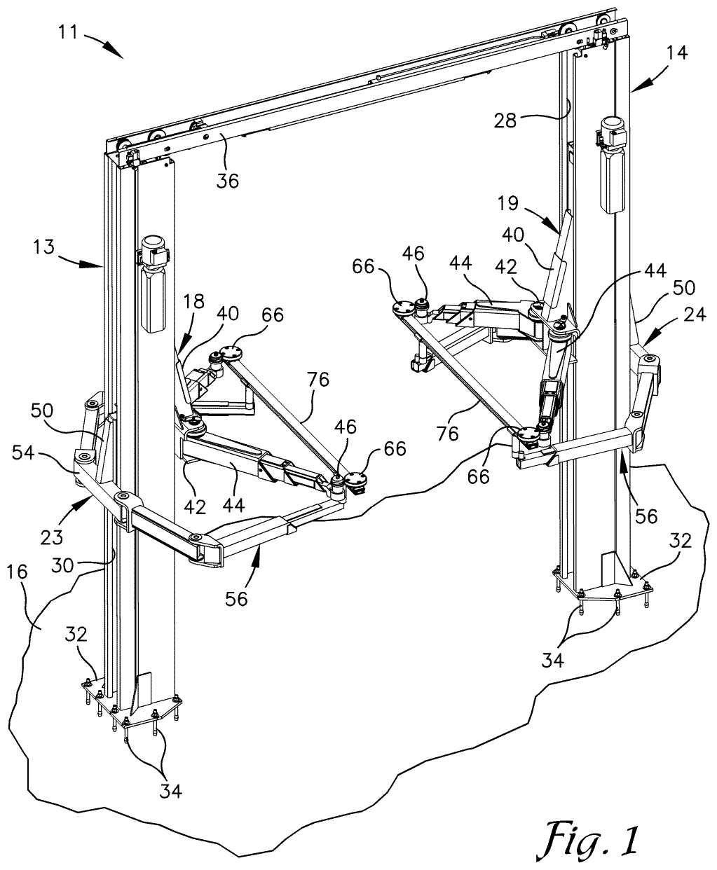

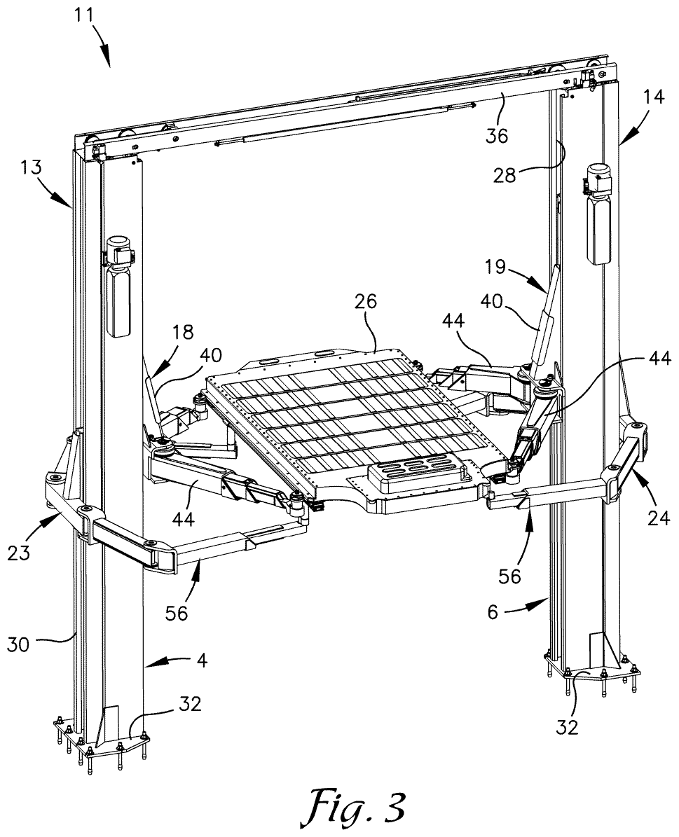

It should be noted that the directional references employed in FIGS. 1-3 are made with respect to the vehicle 21 such that the right and left sides of the apparatus 11 and the vehicle 21 are opposite to the right and left sides of FIGS. 1-3, as viewed.

Each of the illustrated post assemblies 13 and 14 includes a primary lift track or vehicle lift guide 28 extending along an inward side thereof and a secondary lift track or battery lift guide 30 extending along an outward side thereof in parallel relation to the primary lift track 28. Each of the post assemblies 13 and 14 may be formed by a pair of elongated members having a squared C-shape cross section with closed sides joined in back to back relation. Open sides of the post assemblies 13 and 14 form the guides or tracks 28 and 30 with the vehicle lift tracks 28 extending in mutually inward facing relation and the battery lift tracks 30 extending in mutually outward facing relation. Each of the post assemblies 13 and 14 has a base plate 32 through which fasteners, such as bolts 34 pass. The bolts 34 may be embedded in the floor forming the support surface 16, such as a vehicle repair facility floor. Upper ends of the post assemblies 13 and 14 are structurally joined by a trough member 36 through which control conductors, lift cables, and the like may extend.

Each of the illustrated vehicle lift assemblies 18 and 19 includes a primary or vehicle lift carriage 40 which is slidably supported within a respective vehicle lift guide 28 to enable vertical movement therealong. At a lower end of each vehicle lift carriage 40, a vehicle lift clevis 42 is provided which has inner ends of a pair of primary or vehicle lift arm assemblies or arms 44 pivotally connected thereto. Each vehicle lift arm assembly 44 has extendible and retractable, telescoping sections which enable the length of the arm assembly to be selectively adjusted. The illustrated vehicle lift carriage 40 may incorporate a releasable means (not shown) of preventing free pivoting of the arm assemblies relative to the clevis 42 for safety purposes.

As shown in FIGS. 1-3, each vehicle lift arm assembly 44 includes a vehicle contact member 46 at an end thereof. The vehicle contact member 46 is supported at the outer end of each vehicle lift arm 44 for engagement with a lift point of the vehicle 21 to thereby support the load of the vehicle as the vehicle is lifted and lower relative to the support surface. Pivoting and extension or retraction of the vehicle lift arms 44 allows the lift arms 44 to be selectively positionable relative to the vehicle to position the contact members 46 in position to support a portion of the load of the vehicle.

The lift assemblies 18 and 19 may be raised and lowered simultaneously by means of respective primary actuator assemblies or linear actuators, such as hydraulic cylinders 22 (see FIG. 2), connected between post assemblies 13 and 4 respectively and the vehicle lift assemblies 18 and 19. Further details of the vehicle lift assemblies 18 and 19 may be found in U.S. Publication 2021/0331904, previously referenced, the disclosure of which is incorporated herein by reference.

Referring to FIGS. 1-4, the illustrated battery lift assemblies 23 and 24 are substantially similar, and each includes a secondary or battery lift carriage 50 which is slidably positioned within the battery lift guide 30 of the associated post assembly 13 or 14. The battery lift carriages 50 are raised and lowered by a secondary or battery lift actuator 52 (FIG. 8) which, in the illustrated embodiment, is positioned within the trough 36 and engaged with the carriages by means of battery lift cables (not shown) routed therebetween to enable simultaneous lifting and lowering of the carriages 50. The battery lift actuator 52 and battery lift cables comprise an embodiment of a secondary or battery lift actuator assembly. It is foreseen that separate hydraulic actuators may be connected between each battery lift carriage 50 and the respective lift post assemblies 13 and 14 may comprise an alternative battery lift actuator assembly. It is foreseen that some type of ratchet arrangement (not shown) may be engaged between the battery lift carriages 50 and the post assemblies 13 and 14 to limit the descent of the battery 26 in the event of loss of hydraulic pressure by the battery lift actuator 52.

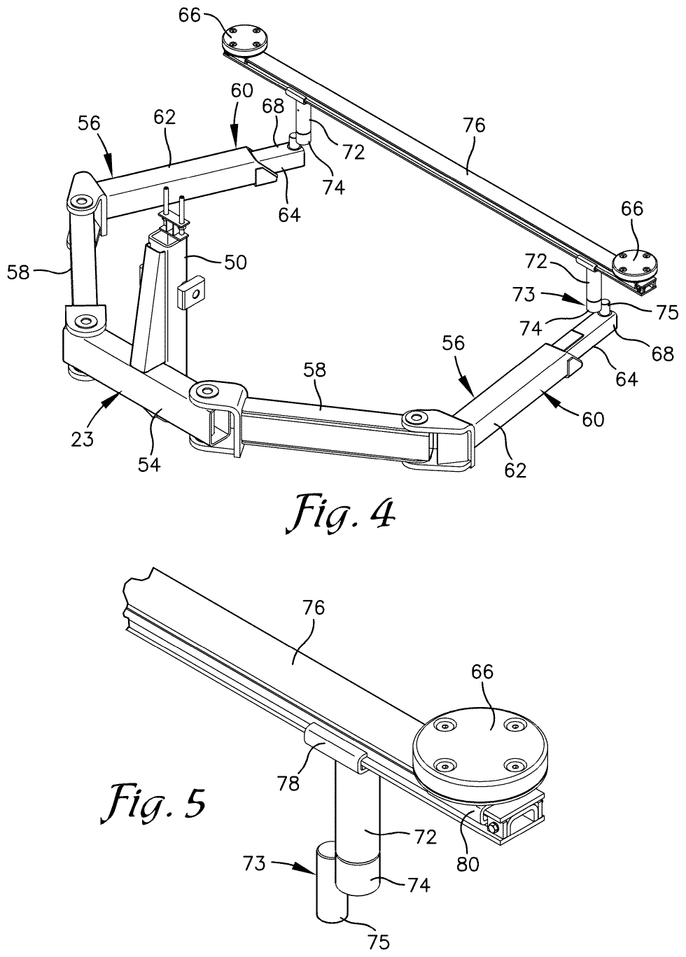

Referring particularly to FIG. 4, each lift carriage 50 includes a lower cross member 54 extending horizontally thereacross. At each end of the cross member 54, a battery lift arm assembly 56 is connected thereto to enable pivoting about a substantially vertical axis. Each of the illustrated battery lift arm assemblies 56 includes an upper arm member 58, which is pivotally connected to the cross member 54, and a telescoping forearm member 60 which is pivotally connected to the upper arm member 58. The terms “upper arm” and “forearm” describing the arm members 58 and 60 are analogous to human anatomical terms. The forearm 60 is formed by an outer arm section 62 which is connected to the cross member 54 and an inner arm section 64 which telescopes into the outer arm section 62.

The inner arm sections 64 may have battery contact pads 66 which may be supported directly on outer ends thereof. In the illustrated battery lift assemblies 23 and 24, the outer ends 68 have battery lift pad extensions 72 upstanding therefrom. The battery lift pad extensions 72 are connected to the outer ends 68 of the arm sections 64 by swivel members 73 which are pivotally connected to the lift pad extensions 72 and to the outer ends 68 of the arm sections 64. The swivel members 73 shown include a cylindrical receiver 74 with a pin or shaft 75 connected to and depending from one side of the receiver 74. A lower end of the lift pad extension 72 is received within the receiver 74, and the pin 75 of the swivel member 73 is received within an opening or receiver (not shown) formed in the distal end of the inner arm section 64 of each battery lift arm assembly 56.

An elongated stiffener member or beam 76 extends between upper ends of the lift pad extensions 72 of each of the battery lift assemblies 23 and 24. In the illustrated battery lift assemblies, the stiffener beam 76 slidably engages extension slide brackets or slides 78 (FIG. 5) positioned at the upper end of each of the lift pad extensions 72. The battery contact pads 66 are supported on the stiffener beam 76 in longitudinally spaced relation thereon by means of battery contact pad side brackets or slides 80. The pivotability of the battery lift arm assemblies 56, the telescoping nature of the forearm members 60, the swivels 74, and the slide brackets 78 and 80 provide a considerable degree of adjustability of the position of the battery contact pads 66 for accurate placement thereof in relation to the battery 26. The stiffener beams 76 provide a degree of rigidness to the battery lift assemblies 23 and 24, when supporting the battery 26, to reduce tendencies to flex the battery.

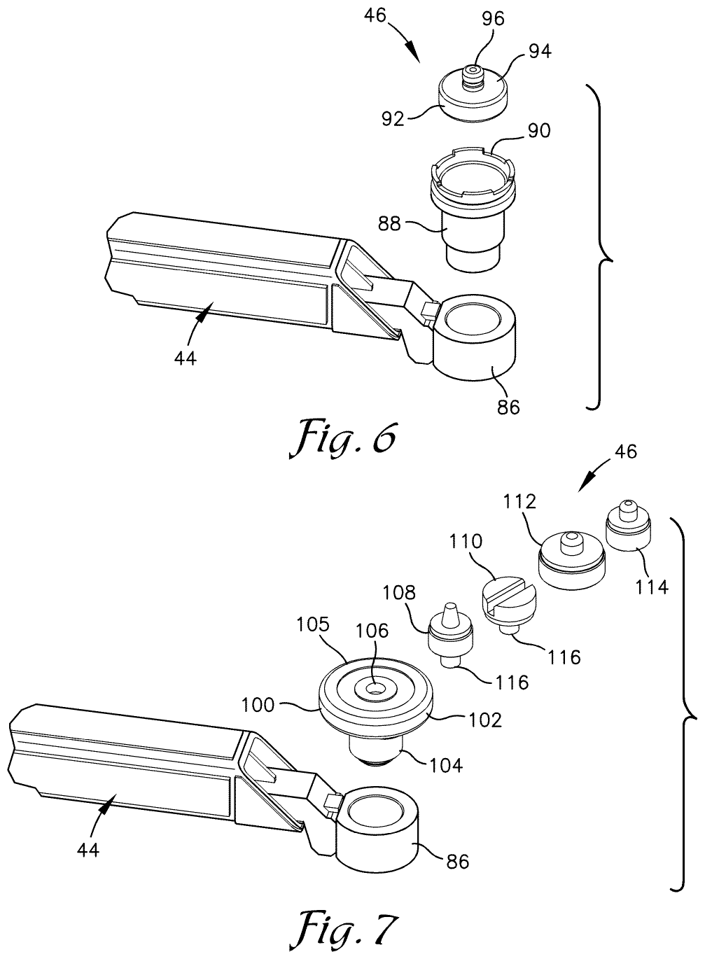

Referring to FIG. 6, the illustrated vehicle contact member or contact adapter 46 may be supported by a contact receiver 86 positioned at an end of one of the vehicle lift arm assemblies 44 by a vertical spacer 88 positioned in the receiver 86 and having a dish adapter or receptacle 90 secured to the top of the spacer 88. A contact pad member or contact adapter 92 is removably positioned on the dish adapter 90 and includes a padding material 94 thereon, such as a hard rubber. The pad member 92 may have an upper shape which may comprise an upstanding center protrusion 96 which is compatible in shape with or mates with a shape of a contact element or lift point fixture (not shown) provided on the underside of the vehicle 21 to provide non-slip engagement therebetween for safe lifting and lowering of the vehicle.

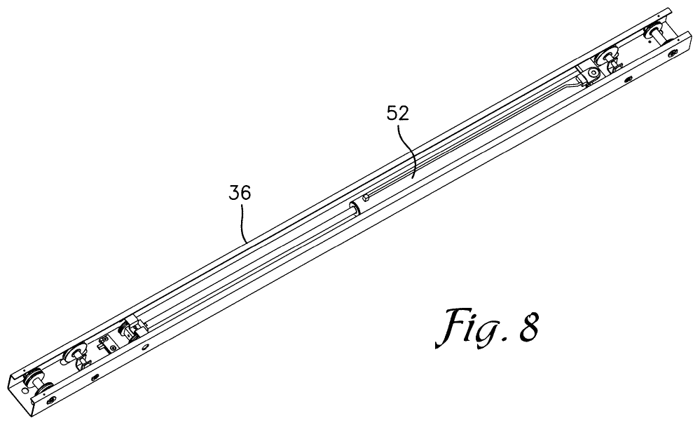

FIG. 7 illustrates modified embodiments of a vehicle contact member 46 including a vehicle contact member 100. The contact member 100 includes an upper contact pad 102 having a mounting shaft 104 depending therefrom. The shaft 104 is sized to be positioned in the contact receiver 86 and may have such a length as to position the body of the vehicle 21 at a specific height above the lift arm assembly 44. The contact pad 102 may be covered by a padding material 105, such as a hard rubber. The contact pad 102 may be provided with a centered aperture or receptacle 106 to receive an additional adapter, such as a selected one of the contact adapters 108, 110, 112, or 114 having varied geometries as shown in FIG. 7, including, for example, an upper surface formed with a protrusion extending therefrom as shown by contact adapters 108, 112, and 114, or an upper surface formed with a recessed portion therein as shown by contact adapter 110, to mate with different features on the underside of the vehicle 21. It is foreseen that adapters having additional alternative configurations can be provided for use with the contact receiver 86 and pad member 100. Each adapter 108, 110, 112, or 114 preferably includes a depending stem 116 for reception within the centered aperture 106 of the contact pad 102. The stem 116 is sized relative to the centered aperture 106 to permit rotation of the associated adapter 108, 110, 112, or 114 relative to the contact pad 102 to permit proper alignment of the adapter 108, 110, 112, or 114 with the mating feature on the vehicle 21.

It is to be understood that while certain forms of the present invention have been illustrated and described herein, it is not to be limited to the specific forms or arrangement of parts described and shown.

What is claimed and desired to be secured by Letters Patent is:

1. A lift arm assembly for use on a two-post lift assembly to engage a load to be lifted, the lift arm assembly comprising:
a lift arm;
a receiver positioned at an end of the lift arm; and
a contact member supported by the receiver and comprising an upper surface shaped to mate with a contact element of a load to be lifted to provide substantially non-slip engagement of the contact member with the contact element.

2. The lift arm assembly of claim 1, wherein the lift arm is positionable relative to the load to position the contact member to engage the contact element of the load.

3. The lift arm assembly of claim 1, wherein the contact member comprises a mounting shaft depending therefrom that is sized to be positioned in the receiver and having a length to position the upper surface of the contact member and the load supported thereon above the lift arm.

4. The lift arm assembly of claim 1, further comprising a spacer between the contact member and the receiver to position the contact member above the lift arm.

5. The lift arm assembly of claim 1, wherein the upper surface of the contact member is formed with a protrusion or a recessed portion that mates with the contact element of the load.

6. The lift arm assembly of claim 1, wherein the contact member comprises one or more contact adapters that are each selectable, and a selected contact adapter provides the upper surface shaped to mate with the contact element of the load.

7. The lift arm assembly of claim 1, wherein the contact member comprises:
a contact pad having a centered aperture formed therein;
a mounting shaft depending from the contact pad and sized to be positioned in the receiver; and
a contact adapter on which the upper surface shaped to mate with the contact element of the load is formed, the contact adapter having a depending stem sized for reception in the centered aperture formed in the contact pad to permit rotation of the contact adapter relative to the contact pad.

8. A lift arm assembly for use on a two-post lift assembly to engage a load to be lifted, the lift arm assembly comprising:
a lift arm;
a receiver positioned at an end of the lift arm; and
a contact member supported by the receiver and comprising a plurality of contact adapters, wherein each of the plurality of contact adapters is selectable such that an upper surface of a selected contact adapter is shaped to mate with a contact element of a load to be lifted to provide substantially non-slip engagement of the contact member with the contact element.

9. The lift arm assembly of claim 8, wherein the lift arm is positionable relative to the load to position the contact member to engage the contact element of the load.

10. The lift arm assembly of claim 8, wherein the contact member comprises a mounting shaft depending therefrom that is sized to be positioned in the receiver and having a length to position the upper surface of the selected contact adapter and the load supported thereon above the lift arm.

11. The lift arm assembly of claim 8, further comprising a spacer between the contact member and the receiver to position the contact member above the lift arm.

12. The lift arm assembly of claim 8, wherein the upper surface of the selected contact adapter is formed with a protrusion or a recessed portion that mates with the contact element of the load.

13. The lift arm assembly of claim 8, wherein the contact member comprises:
a contact pad having a centered aperture formed therein;
a mounting shaft depending from the contact pad and sized to be positioned in the receiver; wherein:
the selected contact adapter has a depending stem sized for reception in the centered aperture formed in the contact pad to permit rotation of the selected contact adapter relative to the contact pad.

14. A lift arm assembly for use on a two-post lift assembly to engage a load to be lifted, the lift arm assembly comprising:
a lift arm;
a receiver positioned at an end of the lift arm; and
a contact member comprising a mounting shaft positioned in the receiver, a receptacle for receiving a contact adapter, and one or more contact adapters, wherein each of the one or more contact adapters is selectable such that an upper surface of a selected contact adapter is shaped to mate with a contact element of a load to be lifted to provide substantially non-slip engagement of the contact member with the contact element, and at least a portion of the selected contact adapter is removably received in the receptacle and is rotatable relative to the receptacle for alignment of the selected contact adapter with the contact element of the load.

15. The lift arm assembly of claim 14, wherein the lift arm is positionable relative to the load to position the contact member to engage the contact element of the load.

16. The lift arm assembly of claim 14, wherein the mounting shaft has a length to position the upper surface of the selected contact adapter and the load supported thereon above the lift arm.

17. The lift arm assembly of claim 14, further comprising a spacer between the contact member and the receiver to position the contact member above the lift arm.

18. The lift arm assembly of claim 14, wherein the upper surface of the selected contact adapter is formed with a protrusion extending therefrom that mates with the contact element of the load.

19. The lift arm assembly of claim 14, wherein the upper surface of the selected contact adapter is formed with a recessed portion formed therein that mates with the contact element of the load.

20. The lift arm assembly of claim 14, wherein the contact member comprises:
a contact pad having the receptacle for receiving the contact adapter formed therein, the receptacle comprising a centered aperture formed in the contact pad; wherein:
the mounting shaft depends from the contact pad, and
the selected contact adapter has a depending stem sized for reception in the centered aperture formed in the contact pad to permit rotation of the selected contact adapter relative to the contact pad.
